(19) United States
(12) Patent Application Publication
(10) Pub. No.: US 2026/0187954 A1
(43) Pub. Date: Jul. 2, 2026

(54) STYLIZED 3D FACE MESH GENERATION METHOD AND APPARATUS

(71) Applicant: Korea Advanced Institute of Science and Technology, Daejeon (KR)

(72) Inventors: Junyong NOH, Daejeon (KR); Kwan YUN, Daejeon (KR); Soyeon YOON, Daejeon (KR); Sihun CHA, Daejeon (KR); Jung Eun YOO, Daejeon (KR); Kwanggyoon SEO, Daejeon (KR)

(21) Appl. No.: 19/420,813

(22) Filed: Dec. 16, 2025

(30) Foreign Application Priority Data
Dec. 30, 2024 (KR) 10-2024-0200181

(51) Int. Cl. G06T 19/20; G06T 13/40

(52) U.S. Cl. CPC G06T 19/20; G06T 13/40; G06T 2219/2021; G06T 2219/2024

(57) ABSTRACT

A method for generating a stylized 3D face mesh according to one embodiment comprises: providing a 3D face mesh to an encoder so that the encoder extracts a shape latent vector for a shape parameter and an expression latent vector for an expression parameter; and providing the shape latent vector and the expression latent vector to a stylized 3D face mesh generation model to generate a stylized 3D face mesh.

### CROSS-REFERENCE TO RELATED APPLICATION

This application claims priority to Korean Patent Application No. 10-2024-0200181, filed on Dec. 30, 2024, the entirety of which is incorporated herein by reference for all purposes.

### TECHNICAL FIELD

An embodiment relates to a method and apparatus for generating a stylized 3D face mesh.

This work was supported by Korea Creative Content Agency grant funded by the Korea government (Ministry of Culture, Sports and Tourism) (Project unique No.: 2370000036; Project No.: 00228331; R&D project: Development of core technologies for global virtual performances; Research Project Title: Development of a universal fashion creation platform technology for expressing avatar individuality; and Project period: 2024.01.01.˜2024.12.31.).

### BACKGROUND

3D face modeling used in the film and game industries requires a significant amount of time and effort from 3D artists due to the complex process of harmoniously combining a character's style with a person's identity. To solve this problem, a 3D face mesh generation method utilizing a deep learning model has been proposed to automate the 3D face modeling process.

However, conventional 3D face mesh generation methods are difficult to apply in real-world industries due to problems such as the inability to accomodate various face topologies, the difficulty in generating new and unique avatar face styles that go beyond the expressive range of existing 3D morphable model (3DMM) technology, and the unsuitability of the generated stylized faces for animation tasks.

### SUMMARY

An object of an embodiment is to provide a technology for generating a stylized 3D face mesh that supports various topologies and styles by providing a latent vector extracted from a 3D face mesh to a stylized 3D face mesh generation model.

However, the problem to be solved by an embodiment is not limited to that mentioned above, and other unmentioned problems to be solved may be clearly understood by a person having ordinary skill in the art to which an embodiment pertains from the following description.

A method for generating a stylized 3D face mesh according to a first aspect of the present invention comprises: providing a 3D face mesh to an encoder so that the encoder extracts a shape latent vector for a shape parameter and an expression latent vector for an expression parameter; and providing the shape latent vector and the expression latent vector to a stylized 3D face mesh generation model to generate a stylized 3D face mesh.

The encoder may be pre-trained to output respective latent vectors for a face shape and an expression of an input 3D face mesh.

The encoder may include a first multi-layer perceptron (MLP) that outputs the shape latent vector based on the 3D face mesh and a second MLP that outputs the expression latent vector based on the 3D face mesh.

The stylized 3D face mesh generation model may be pre-trained to generate a stylized 3D face mesh based on a reference 3D face mesh, a target deformed 3D face mesh whose style is deformed from the reference 3D face mesh, a deformed 3D face mesh whose style is deformed from the reference 3D face mesh through the stylized 3D face mesh generation model, a sampled 3D face mesh generated based on a latent vector randomly sampled from a database, and a deformed sampled 3D face mesh whose style is deformed from the sampled 3D face mesh through the stylized 3D face mesh generation model.

The reference 3D face mesh and the sampled 3D face mesh may be generated through a surface deformation network. Furthermore, the surface deformation network may be pre-trained to generate a 3D face mesh by receiving a shape parameter and an expression parameter as input, based on a target 3D face mesh output from a statistics-based 3D face mesh generation model.

In the training of the stylized 3D face mesh generation model, the stylized 3D face mesh generation model may be trained to minimize a vertex difference between the target deformed 3D face mesh and the deformed 3D face mesh, while maintaining parameters of the surface deformation network.

In the training of the stylized 3D face mesh generation model, the stylized 3D face mesh generation model may be trained to minimize a difference in contrastive language-image pre-training (CLIP) embedding values between the target deformed 3D face mesh and the deformed 3D face mesh, while maintaining parameters of the surface deformation network.

In the training of the stylized 3D face mesh generation model, the stylized 3D face mesh generation model may be trained to minimize a difference in surface normal values between the target deformed 3D face mesh and the deformed sampled 3D face mesh, while maintaining parameters of the surface deformation network.

In the training of the stylized 3D face mesh generation model, the stylized 3D face mesh generation model may be trained to minimize a difference between a direction of a difference vector for a CLIP embedding value for the reference 3D face mesh and a CLIP embedding value for the sampled 3D face mesh, and that of a difference vector for a CLIP embedding value for the target deformed 3D face mesh and a CLIP embedding value for the deformed sampled 3D face mesh, while maintaining parameters of the surface deformation network.

In the training of the stylized 3D face mesh generation model, the stylized 3D face mesh generation model may be trained to minimize a difference between a direction of a difference vector for a CLIP embedding value for the reference 3D face mesh and a CLIP embedding value for the target deformed 3D face mesh, and that of a difference vector for a CLIP embedding value for the sampled 3D face mesh and a CLIP embedding value for the deformed sampled 3D face mesh, while maintaining parameters of the surface deformation network.

A method for training a stylized 3D face mesh generation model according to a second aspect of the present invention comprises: pre-training a surface deformation network to generate a 3D face mesh by receiving a shape parameter and an expression parameter as input, based on a target 3D face mesh output from a statistics-based 3D face mesh generation model; obtaining a reference 3D face mesh generated through the surface deformation network and a deformed 3D face mesh whose style is deformed from the reference 3D face mesh; and training a stylized 3D face mesh generation model based on the reference 3D face mesh and the deformed 3D face mesh.

An apparatus for generating a stylized 3D face mesh according to a third aspect of the present invention comprises a memory storing computer-executable instructions and a processor, wherein as the computer-executable instructions are executed by the processor, a shape latent vector for a shape parameter and an expression latent vector for an expression parameter are extracted by providing a 3D face mesh to an encoder, and a stylized 3D face mesh is generated by providing the shape latent vector and the expression latent vector to a stylized 3D face mesh generation model.

A non-transitory computer-readable storage medium according to a fourth aspect of the present invention stores computer-executable instructions, wherein the computer-executable instructions, when executed by a processor, cause the processor to perform a method comprising: providing a 3D face mesh to an encoder so that the encoder extracts a shape latent vector for a shape parameter and an expression latent vector for an expression parameter; and providing the shape latent vector and the expression latent vector to a stylized 3D face mesh generation model to generate a stylized 3D face mesh.

A computer program according to a fifth aspect of the present invention is stored on a non-transitory computer-readable storage medium, wherein the computer program, when executed by a processor, comprises instructions for causing the processor to perform a method comprising: providing a 3D face mesh to an encoder so that the encoder extracts a shape latent vector for a shape parameter and an expression latent vector for an expression parameter; and providing the shape latent vector and the expression latent vector to a stylized 3D face mesh generation model to generate a stylized 3D face mesh.

According to the above aspects, by automating the complex process of 3D avatar face modeling in the film and game industries, a stylized 3D face mesh that harmoniously combines a character's ‘style’ and a specific person's ‘identity’ may be generated.

Furthermore, since a stylized 3D face mesh may be generated corresponding to various face topologies, time and costs in the character design process may be significantly reduced. In particular, a stylized face of a desired topology may be generated from various forms of face meshes through a mesh agnostic encoder (MAGE). Based on this, creators may reuse existing animation rigs and texture maps for other models, maximizing work efficiency.

Furthermore, high-quality, various stylized faces may be generated even with a small amount of data, and accordingly, the difficulty and cost of data collection may be significantly reduced. Therefore, user-customized 3D avatars may be easily generated and utilized on social media and virtual reality (VR) platforms.

Furthermore, the method for generating a stylized 3D face mesh according to an embodiment may be used in various application fields. For example, the efficiency of character design and animation tasks in the film and game industries is improved, and user-customized 3D avatars may be easily generated on social media and virtual reality (VR) platforms. Through this, an embodiment supports the production of creative and realistic digital content throughout the cultural content industry, and may further contribute to enhancing the user experience.

The effects obtainable from an embodiment are not limited to the effects mentioned above, and other unmentioned effects may be clearly understood by a person having ordinary skill in the art to which an embodiment pertains from the following description.

### BRIEF DESCRIPTION OF THE DRAWINGS

FIG. 1 is a block diagram illustrating an apparatus for generating a stylized 3D face mesh according to the third aspect.

FIG. 2 is a block diagram illustrating the functions of a stylized 3D face mesh generation program.

FIG. 3 is a flowchart illustrating a method for generating a stylized 3D face mesh according to the first aspect.

FIG. 4 is a diagram illustrating a method for pre-training a surface deformation network according to the second aspect.

FIG. 5 is a diagram illustrating a method for fine-tuning a stylized 3D face mesh generation model.

FIG. 6 is a diagram illustrating hierarchical rendering according to an embodiment.

FIG. 7 is a diagram illustrating a process of constructing an encoder for extracting a latent vector to be input to a stylized 3D face mesh generation model.

FIG. 8 is a diagram illustrating an inference process of a stylized 3D face mesh generation model according to an embodiment.

FIG. 9 is a table illustrating a comparison result between a stylized 3D face mesh generation method according to an embodiment and a conventional mesh sampling method in terms of mesh reconstruction.

FIG. 10 is a table illustrating a comparison result between a stylized 3D face mesh generation method and a conventional 3D face mesh generation method for an ablation study.

FIG. 11 is a diagram illustrating a comparison result between a stylized 3D face mesh generation method and a conventional 3D face mesh generation method in terms of stylization performance.

### DETAILED DESCRIPTION

The advantages and features of an embodiment, and methods for achieving them, will become clear with reference to the embodiments described in detail below in conjunction with the accompanying drawings. However, the disclosed invention is not limited to the embodiments disclosed below but may be implemented in various different forms; these embodiments are provided only to make the disclosure of an embodiment complete and to fully inform those skilled in the art of the scope of the invention, and the scope of the invention is only defined by the scope of the claims.

In describing embodiments, when it is determined that a detailed description of a known function or configuration may unnecessarily obscure the gist of an embodiment, the detailed description thereof will be omitted. The terms used below are defined in consideration of their functions in an embodiment and may vary depending on the intention or practice of a user or operator. Therefore, their definitions should be made based on the content throughout this specification.

The terms used in this specification will be briefly described, and the present invention will be described in detail.

The terms used in this specification have been selected from general terms that are currently widely used, considering the functions in an embodiment, but this may vary depending on the intention of a person skilled in the art, legal precedents, the emergence of new technologies, and so on. Also, in specific cases, there are terms arbitrarily selected by the applicant, and in such cases, their meanings will be described in detail in the corresponding description of the invention. Therefore, the terms used herein should be defined based on the meaning of the term and the content throughout this disclosure, not just the name of the term.

Throughout the specification, when a part is said to “include” a certain component, it means that other components may be further included, not that other components are excluded, unless there is a specific statement to the contrary.

Furthermore, the term ‘unit’ as used in the specification refers to a software or hardware component such as an FPGA or ASIC, and a ‘unit’ performs certain roles. However, ‘unit’ is not limited to software or hardware. A ‘unit’ may be configured to be in an addressable storage medium and to be played back by one or more processors. Accordingly, as an example, a ‘unit’ includes components such as software components, object-oriented software components, class components, and task components, and processes, functions, attributes, procedures, subroutines, segments of program code, drivers, firmware, microcode, circuits, data, databases, data structures, tables, arrays, and variables. The functions provided in the components and ‘units’ may be combined into a smaller number of components and ‘units’ or further separated into additional components and ‘units’.

Hereinafter, embodiments will be described in detail with reference to the accompanying drawings so that a person having ordinary skill in the art to which the disclosed invention pertains may easily carry out the disclosed invention.

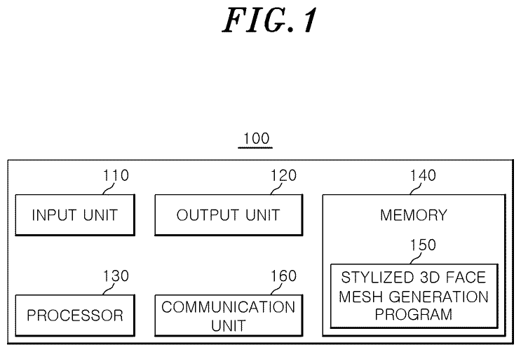

FIG. 1 is a block diagram illustrating an apparatus for generating a stylized 3D face mesh according to the third aspect.

As shown in FIG. 1, the stylized 3D face mesh generation apparatus 100 may include an input unit 110, an output unit 120, a processor 130, a memory 140, or a communication unit 160.

Hereinafter, for convenience of explanation, it is described as an example that the stylized 3D face mesh generation apparatus 100 includes the input unit 110, the output unit 120, the processor 130, the memory 140, or the communication unit 160, but it is not limited thereto. That is, each unit component may be provided outside the stylized 3D face mesh generation apparatus 100 and operate in a manner that interacts with the stylized 3D face mesh generation apparatus 100.

The input unit 110 may include a user interface for receiving commands, information, and the like used to control the stylized 3D face mesh generation apparatus 100. Furthermore, the input unit 110 may be a hardware device (e.g., a keyboard, mouse, touch pad, etc.) capable of directly receiving commands, information, and the like used to control the stylized 3D face mesh generation apparatus 100.

In an embodiment, the input unit 110 may receive information necessary for the stylized 3D face mesh generation method from a user. Specifically, the user may input information including a 3D face mesh, information related to a surface deformation network, information related to a stylized 3D face mesh generation model, information related to CLIP, and information related to MAGE through the input unit 110.

The output unit 120 may provide information including a 3D face mesh, information related to a surface deformation network, information related to a stylized 3D face mesh generation model, information related to CLIP, information related to MAGE, a latent vector, and a style-deformed 3D face mesh to a user as visual information through an interface.

The processor 130 may generally control the operation of the stylized 3D face mesh generation apparatus 100 to perform operations according to an embodiment.

The processor 130 may load the stylized 3D face mesh generation program 150 and information necessary for the execution of the stylized 3D face mesh generation program 150 from the memory 140 and execute the stylized 3D face mesh generation program 150.

The processor 130 may control the stylized 3D face mesh generation apparatus 100 to store data received from an external device in the memory 140 via the communication unit 160. Furthermore, the processor 130 may control the stylized 3D face mesh generation apparatus 100 to transmit and receive information including a 3D face mesh, information related to a surface deformation network, information related to a stylized 3D face mesh generation model, information related to CLIP, information related to MAGE, a latent vector, and a style-deformed 3D face mesh to and from an external device via the communication unit 160.

The processor 130 may refer to a processing device such as a microprocessor, a central processing unit (CPU), a graphic processing unit (GPU), a processor core, a multiprocessor, an application-specific integrated circuit (ASIC), a field programmable gate array (FPGA), or a micro controller unit (MCU), but is not limited to the above-described embodiments.

The memory 140 may store the stylized 3D face mesh generation program 150 and information necessary for the execution of the stylized 3D face mesh generation program 150. Furthermore, the memory 140 may also store the processing results from the processor 130.

The stylized 3D face mesh generation program 150 may refer to software including instructions programmed to perform the method according to an embodiment.

The memory 140 may store information including a 3D face mesh, information related to a surface deformation network, information related to a stylized 3D face mesh generation model, information related to CLIP, information related to MAGE, a latent vector, and a style-deformed 3D face mesh. Furthermore, the memory 140 may store information received from an external device via the communication unit 160.

The memory 140 may refer to a computer-readable storage medium such as a magnetic media like a hard disk, a floppy disk, and a magnetic tape, an optical media like a CD-ROM and a DVD, a magneto-optical media like a floptical disk, a random access memory like a dynamic random access memory (DRAM) and a static random access memory (SRAM), or a hardware device specially configured to store and execute program instructions like a flash memory, but is not limited to the above-described embodiments.

The communication unit 160 may be a wireless communication module capable of performing wireless communication by adopting a communication method such as CDMA, GSM, W-CDMA, TD-SCDMA, WiBro, LTE, EPC, 5G, wireless LAN, Wi-Fi, Bluetooth, Zigbee, Wi-Fi Direct (WFD), Ultra Wide Band (UWB), Infrared Data Association (IrDA), Bluetooth Low Energy (BLE), or Near Field Communication (NFC), but is not limited to the above-described embodiments.

Furthermore, the information input and output through the input unit 110 and the output unit 120, the information stored in the memory 140, and the information transmitted and received through the communication unit 160 include all information related to an embodiment, and are not limited to the above-described embodiments.

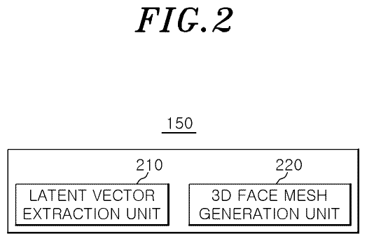

The functions or operations of the stylized 3D face mesh generation program 150 will be examined in detail with reference to FIG. 2.

FIG. 2 is a block diagram illustrating the functions of a stylized 3D face mesh generation program.

As shown in FIG. 2, the stylized 3D face mesh generation program 150 may include a latent vector extraction unit 210 and a 3D face mesh generation unit 220. The latent vector extraction unit 210 and the 3D face mesh generation unit 220 are exemplary divisions of the functions of the stylized 3D face mesh generation program 150, and are not limited thereto.

According to embodiments, the functions of each of the latent vector extraction unit 210 and the 3D face mesh generation unit 220 may be merged or separated, and may be implemented as a series of instructions included in at least one program.

The latent vector extraction unit 210 and the 3D face mesh generation unit 220 may be implemented by the processor 130 and may refer to a data processing device embedded in hardware, having physically structured circuits to perform the functions represented by code or commands included in the stylized 3D face mesh generation program 150 stored in the memory 140.

The latent vector extraction unit 210 may provide a 3D face mesh to an encoder to extract a shape latent vector for a shape parameter and an expression latent vector for an expression parameter.

In an embodiment, the encoder may be pre-trained to output respective latent vectors for a face shape and an expression of an input 3D face mesh.

In an embodiment, the encoder may include a first multi-layer perceptron (MLP) that outputs a shape latent vector based on the 3D face mesh and a second MLP that outputs an expression latent vector based on the 3D face mesh.

The 3D face mesh generation unit 220 may provide the shape latent vector and the expression latent vector to a stylized 3D face mesh generation model to generate a stylized 3D face mesh.

In an embodiment, the stylized 3D face mesh generation model may be pre-trained to generate a stylized 3D face mesh based on a reference 3D face mesh, a target deformed 3D face mesh whose style is deformed from the reference 3D face mesh, a deformed 3D face mesh whose style is deformed from the reference 3D face mesh through the stylized 3D face mesh generation model, a sampled 3D face mesh generated based on a latent vector randomly sampled from a database, and a deformed sampled 3D face mesh whose style is deformed from the sampled 3D face mesh through the stylized 3D face mesh generation model.

The reference 3D face mesh and the sampled 3D face mesh may be generated through a surface deformation network.

The surface deformation network may be pre-trained to generate a 3D face mesh by receiving a shape parameter and an expression parameter as input, based on a target 3D face mesh output from a statistics-based 3D face mesh generation model. Here, the statistics-based 3D face mesh generation model may be FLAME (faces learned with an articulated model and expressions), but is not limited thereto.

In the training of the stylized 3D face mesh generation model, the parameters of the surface deformation network may be frozen.

In an embodiment, the stylized 3D face mesh generation model may be trained to minimize a vertex difference between the target deformed 3D face mesh and the deformed 3D face mesh.

In an embodiment, the stylized 3D face mesh generation model may be trained to minimize a difference in contrastive language-image pre-training (CLIP) embedding values between the target deformed 3D face mesh and the deformed 3D face mesh.

In an embodiment, the stylized 3D face mesh generation model may be trained to minimize a difference in surface normal values between the target deformed 3D face mesh and the deformed sampled 3D face mesh.

In an embodiment, while maintaining the parameters of the surface deformation network, the stylized 3D face mesh generation model may be trained to minimize a difference between a direction of a difference vector for a CLIP embedding value for the reference 3D face mesh and a CLIP embedding value for the sampled 3D face mesh, and a difference vector for a CLIP embedding value for the target deformed 3D face mesh and a CLIP embedding value for the deformed sampled 3D face mesh.

In an embodiment, the stylized 3D face mesh generation model may be trained to minimize a difference between a direction of a difference vector for a CLIP embedding value for the reference 3D face mesh and a CLIP embedding value for the target deformed 3D face mesh, and a difference vector for a CLIP embedding value for the sampled 3D face mesh and a CLIP embedding value for the deformed sampled 3D face mesh.

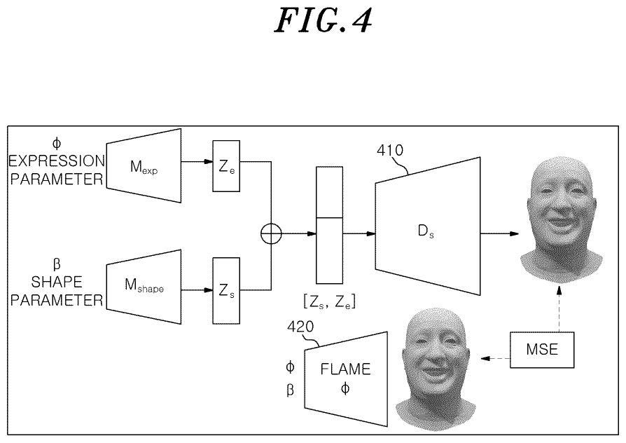

The learning process of the surface deformation network, the stylized 3D face mesh generation model, or MAGE will be described in detail with reference to FIGS. 4 to 7.

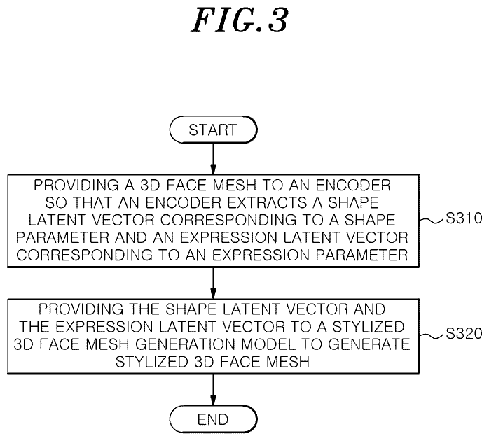

FIG. 3 is a flowchart illustrating a method for generating a stylized 3D face mesh according to the first aspect. The method shown in FIG. 3 may be executed by the stylized 3D face mesh generation apparatus 100 shown in FIG. 1. In addition, the flowchart shown in FIG. 3 is merely exemplary, and according to embodiments, each step may be executed in a different order from that described in the flowchart, or steps not described in the flowchart may be additionally executed, or one or more of the steps described in the flowchart may not be executed.

As shown in FIG. 3, a method for generating a stylized 3D face mesh according to an embodiment is performed by including providing a 3D face mesh to an encoder to extract a shape latent vector for a shape parameter and an expression latent vector for an expression parameter (S310); and providing the shape latent vector and the expression latent vector to a stylized 3D face mesh generation model to generate a stylized 3D face mesh (S320).

A mesh may refer to a standardized mesh that defines the basic structure of a 3D object. The mesh may include a certain number of vertices and faces. Operations for deformation (e.g., surface movement, enlargement, etc.) may be performed based on the mesh in a 3DMM.

A 3D morphable model (3DMM) may be a statistical model used to represent 3D objects such as faces. Based on a plurality of actually captured 3D mesh data, a 3DMM may learn geometry and texture to generate or modify a 3D representation for a specific object such as a face. As input data for the 3DMM, a base mesh, a shape parameter, and an expression parameter may be input, and as output data, a deformed mesh may be output.

A method for training a stylized 3D face mesh generation model according to another embodiment is performed by including pre-training a surface deformation network to generate a 3D face mesh by receiving a shape parameter and an expression parameter as input, based on a target 3D face mesh output from a statistics-based 3D face mesh generation model; obtaining a reference 3D face mesh generated through the surface deformation network and a target deformed 3D face mesh whose style is deformed from the reference 3D face mesh; and training a stylized 3D face mesh generation model based on the reference 3D face mesh and the target deformed 3D face mesh. At this time, the method for training the stylized 3D face mesh generation model may be performed by a training apparatus. The training apparatus here may include a predetermined processor as described in FIG. 1, but is not limited thereto.

FIG. 4 is a diagram illustrating a method for pre-training a surface deformation network according to the second aspect.

A surface deformation network may refer to a deep learning-based model used in 3D graphics or computer vision that takes a given latent vector as input to deform a mesh. In the surface deformation network, a new shape may be generated by adjusting the vertex positions of the mesh, or the deformed surface of an object may be modeled. According to an embodiment, so that the surface deformation network may operate similarly to a 3DMM, shape information and expression information may be reflected based on the input latent vector, and a 3D face mesh may be output. In an embodiment, as input data for the surface deformation network, an initial mesh, a shape parameter, and an expression parameter may be input, and as output data, a deformed mesh may be output.

FLAME is a type of 3DMM, which may refer to an integrated 3D model used to model the shape and expression of a face through a shape parameter β and an expression parameter φ. Here, the overall shape of the face (e.g., face size, nose length, or chin shape, etc.) may be defined according to the shape parameter β. Furthermore, the deformation of expressions such as smiling, anger, frowning, or surprise may be controlled according to the expression parameter φ. Using FLAME, the vertex positions of the mesh may be adjusted according to the parameters to generate the shape and expression of the face. In FLAME, the shape and expression of the face may be manipulated through the shape parameter β and the expression parameter φ.

The shape parameter and the expression parameter may be obtained through an analysis technique such as principal component analysis (PCA) based on 3D face data extracted from a plurality of people. The shape parameter represents an individual's facial structure and may determine the size and form of the face by indicating major variations from the average face shape (e.g., nose height, face width). The expression parameter may represent the way a face moves through muscle changes or geometric deformations according to changes in expression (e.g., the degree of lip opening, changes in eyebrow position).

In an embodiment, a FLAME decoder may be connected to a surface deformation network, so that when a shape parameter β and an expression parameter φ are input, a surface deformation network (410, Dₛ) that may generate various geometric face shapes and expressions may be constructed.

So that a 3D face may be generated when a shape parameter β and an expression parameter φ are input, mapping networks Mₛₕₐₚₑ and Mₑₓₚ, which are composed of a multi-layer perceptron (MLP), may be used. Each mapping network may transform the shape parameter β and the expression parameter φ into respective latent vectors Zₛ and Zₑ. The transformed latent vectors Zₛ and Zₑ are input to the surface deformation network 410 to generate a 3D face with various expressions.

For the training of the surface deformation network 410, a predetermined FLAME decoder 420 may be used. Specifically, the training of the surface deformation network 410 may proceed by comparing the vertices of a 3D face mesh generated by the surface deformation network 410 based on a predetermined latent vector with the vertices of a face mesh manipulated through the FLAME decoder 420 using a mean square error (MSE) loss function. Through this training process, the surface deformation network 410 may be trained to effectively generate various face shapes and expressions according to the input shape parameter and expression parameter φ.

In an embodiment, the training of the surface deformation network 410 may include a surface intensive mesh sampling (SIMS) technique. Surface intensive mesh sampling may refer to a method of finely sampling specific regions in mesh data. In 3D face mesh generation or modeling, SIMS is a method of increasing the sampling density in important parts of the face surface (e.g., areas with detailed features such as the eyes, nose, and mouth), which may maximize the detailed information of the necessary areas while maintaining the quality of the overall mesh. Specifically, by randomly sampling points over the entire surface of the mesh through surface intensive mesh sampling, the 3D face mesh generation model may be made to learn various face topology forms. Surface intensive mesh sampling may randomly sample more points on the surface than the number of vertices in the face mesh. For example, surface intensive mesh sampling may sample points from the entire surface, not just using the vertices of the mesh. Through this surface intensive mesh sampling, the surface deformation network 410 allows the 3D face mesh generation model to learn various face topology forms more accurately.

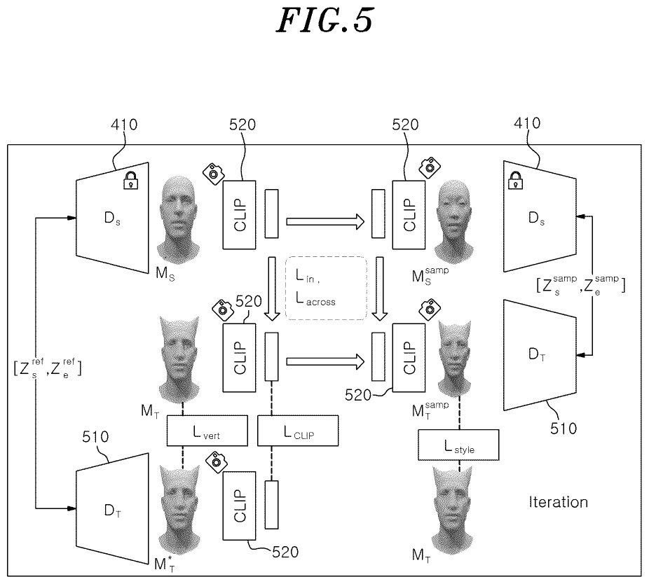

FIG. 5 is a diagram illustrating a method for fine-tuning a stylized 3D face mesh generation model.

As shown in FIG. 5, the fine-tuning process of the stylized 3D face mesh generation model 510 may include operations performed by the surface deformation network (410, Dₛ) pre-trained through the training process of FIG. 4, the stylized 3D face mesh generation model (510, D_{T}), and CLIP (520, contrastive language-image pre-training).

The goal of the fine-tuning process of the stylized 3D face mesh generation model 510 may be to construct a stylized 3D face mesh generation model 510 that may generate a 3D face by changing the style of the generation domain of the generated 3D face mesh from a source face to a target style face. In an embodiment, the source face may be a human face, and the target style face may be a non-human face, but it is not limited thereto.

To construct a pair of data used for the fine-tuning of the stylized 3D face mesh generation model 510, reference latent vectors zₛ^{ref} and zₑ^{ref} may be prepared. zₛ^{ref} and zₑ^{ref} may be provided to the surface deformation network 410 to generate an identity exemplar mesh (MS). Here, the identity exemplar mesh may be used for training as a reference 3D face mesh. Furthermore, a style exemplar mesh (M_{T}) whose style is changed from the identity exemplar mesh may be prepared. The style exemplar mesh may be used for training as a target deformed 3D face mesh. The identity exemplar mesh and the style exemplar mesh may serve to guide the fine-tuning process. Furthermore, zₛ^{ref} and zₑ^{ref} may be provided to the stylized 3D face mesh generation model 510 to generate a deformed 3D face mesh (M_{T}*) whose style is deformed from the identity exemplar mesh or the 3D face mesh.

In each iteration of the fine-tuning process zₛ^{ref} and zₑ^{ref} may be obtained by random sampling. zₛ^{ref} and zₑ^{ref} may be provided to the surface deformation network 410 to generate a sampled 3D face mesh (Mₛ^{samp}). Furthermore, zₛ^{ref} and zₑ^{ref} may be provided to the stylized 3D face mesh generation model 510 to generate a deformed sampled 3D face mesh (M_{T}^{samp}) whose style is deformed from the sampled 3D face mesh (Mₛ^{samp}).

For the training of the stylized 3D face mesh generation model 510 according to FIG. 5, CLIP 520 may be used. CLIP 520 is an image-text encoder trained on image and text pairs, and according to one embodiment, the image encoder of CLIP 520 may be used. A 2D image generated by rendering a mesh may be input to the image encoder of CLIP 520 to extract the features of the corresponding mesh.

In the training of the stylized 3D face mesh generation model 510 according to FIG. 5, the weights of the surface deformation network 410 pre-trained through the training process of FIG. 4 are frozen, while the stylized 3D face mesh generation model 510 is initialized with the same structure and weights as the surface deformation network 410 pre-trained through the training process of FIG. 4, but may be set to a trainable state. In this fine-tuning process of the stylized 3D face mesh generation model 510, various loss functions are applied between the generated 3D face meshes, so that the stylized 3D face mesh generation model 510 may be gradually adjusted to generate a stylized face. Hereinafter, various loss functions used in the fine-tuning process of the stylized 3D face mesh generation model 510 will be described.

The vertex reconstruction loss (Lᵥₑᵣₜ) is a loss function used to accurately restore the positions of vertices in a 3D mesh, and may be used to train a model to deform the mesh while maintaining a target style. Specifically, the stylized 3D face mesh generation model 510 may be trained to minimize the vertex difference between the target deformed 3D face mesh (M_{T}) and the deformed 3D face mesh (M_{T}*) generated from the stylized 3D face mesh generation model 510.

The CLIP reconstruction loss (LCLIP) is a loss function used to reconstruct image or text representations and make them similar to target data, and may be used to maintain model consistency in the representation space between text and images. Specifically, the stylized 3D face mesh generation model 510 may be trained to minimize the difference in CLIP embedding values between the target deformed 3D face mesh (M_{T}) and the deformed 3D face mesh (M_{T}*) generated from the stylized 3D face mesh generation model 510.

The style loss (Lstyle) is a loss function used to train a model to maintain a specific style in a stylized 3D face mesh and may be calculated using surface normals. In this case, the surface normal is a vector that defines the orientation of a mesh surface and may be a vector pointing perpendicularly from a specific point on the given mesh surface. Specifically, the stylized 3D face mesh generation model 510 may be trained to minimize the difference in surface normal values between the target deformed 3D face mesh (M_{T}) and the deformed sampled 3D face mesh (M_{T}^{samp}) generated from the stylized 3D face mesh generation model 510.

The CLIP in-domain loss is a loss function used to maintain consistency within the same domain, for example, to ensure that the semantic differences between faces in the source face (human face) domain are consistently maintained in the target style face (non-human face) domain. For example, the reference 3D face mesh (M_{S}) and the sampled 3D face mesh (M_{S}^{samp}) may be meshes corresponding to human faces, and the target deformed 3D face mesh (M_{T}), the deformed 3D face mesh (M_{T}*), and the deformed sampled 3D face mesh (M_{T}^{samp}) may be meshes corresponding to non-human avatar faces. In this case, the stylized 3D face mesh generation model 510 may be trained to minimize the difference between a direction of a difference vector for a CLIP embedding value for the reference 3D face mesh (M_{S}) and a CLIP embedding value for the sampled 3D face mesh (M_{S}^{samp}), and a difference vector for a CLIP embedding value for the target deformed 3D face mesh (M_{T}) and a CLIP embedding value for the deformed sampled 3D face mesh (M_{T}^{samp}).

The CLIP across-domain loss is a loss function used to maintain consistency between different domains, for example, to ensure that for multiple faces with different identities, the semantic difference between the source face (human face) domain and the target style (non-human face) domain is consistently maintained. Specifically, the stylized 3D face mesh generation model 510 may be trained to minimize the difference between a direction of a difference vector for a CLIP embedding value for the reference 3D face mesh (M_{S}) and a CLIP embedding value for the target deformed 3D face mesh (M_{T}), and a difference vector for a CLIP embedding value for the sampled 3D face mesh (M_{S}^{samp}) and a CLIP embedding value for the deformed sampled 3D face mesh (M_{T}^{samp}).

In the training process of the stylized 3D face mesh generation model 510 through the aforementioned loss functions, the parameters of the surface deformation network may be frozen.

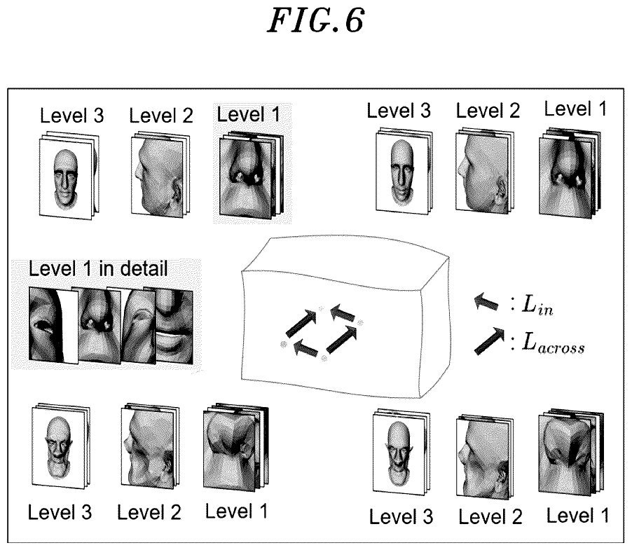

FIG. 6 is a diagram illustrating hierarchical rendering according to an embodiment.

A hierarchical rendering method may be introduced in the fine-tuning process of the stylized 3D face mesh generation model 510 of FIG. 5. The hierarchical rendering method may be a method of effectively acquiring local and localized features of a face during the 3D face stylization process. As shown in FIG. 6, the hierarchical rendering method may be used to render important detailed elements of the face at various resolutions and viewpoints so that the style is reflected on the face while the identity of the stylized face is maintained.

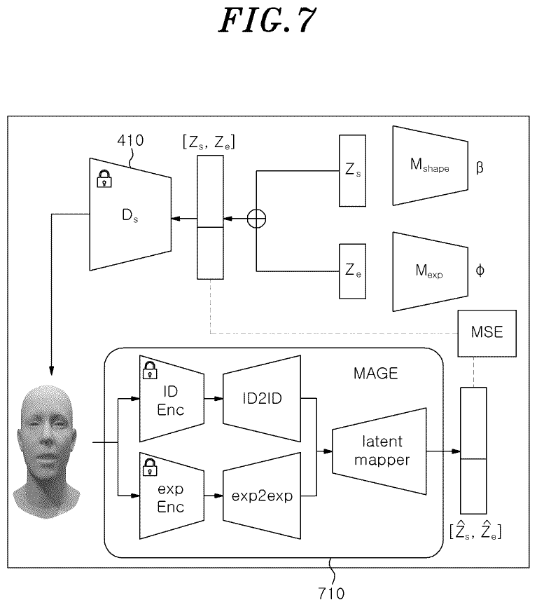

FIG. 7 is a diagram illustrating a process of constructing an encoder for extracting a latent vector to be input to a stylized 3D face mesh generation model.

MAGE (710, mesh agnostic encoder) may refer to an encoder designed to learn and process the shape and expression of a 3D face mesh. MAGE 710 may utilize an encoder pre-trained in neural face rigging (NFR) to transform the shape and expression of a face mesh into a high-dimensional latent vector space. As input data for MAGE 710, a mesh may be input, and as output data, a latent vector may be output. MAGE 710 may include an identity-to-identity (ID2ID), an expression-to-expression (exp2exp), and a latent mapper, which will be described below.

The NFR may refer to a neural network-based technology for manipulating a 3D face mesh. In traditional rigging methods, each part of the mesh must be controlled manually, but NFR may automatically model complex deformations of the face (e.g., blinking, lip movements, etc.) through a neural network. Through this method, shape information and expression information of the face mesh may be extracted.

The ID2ID and exp2exp may refer to two separate multi-layer perceptron (MLP) networks used in MAGE 710. ID2ID may learn the unique identity (ID) information of an individual for a face mesh and convert it into a latent vector. In this process, information about the overall facial structure of the mesh (e.g., jaw line, nose shape, etc.) may be processed. In an embodiment, ID2ID may receive a 3D face mesh and output a shape latent vector, which is a latent vector for a shape parameter.

The exp2exp may learn the expression information of a face mesh and transform it into a latent vector. In this training process, the expression methods for expressions such as lip shape, eyebrow movement, etc., may be learned. In an embodiment, exp2exp may receive a 3D face mesh and output an expression latent vector, which is a latent vector for an expression parameter.

The latent mapper may perform the operation of receiving the shape latent vector and the expression latent vector generated by ID2ID and exp2exp and mapping them into a specific format that may be used to generate or edit a 3D face mesh.

MAGE 710 extracts shape and expression information from a 3D face mesh using an encoder pre-trained in NFR, and may generate latent vectors and by using two MLPs, ID2ID and exp2exp, for the extracted shape and expression information.

The generated latent vectors zs and ze are provided to the stylized 3D face mesh generation model 510 and may be used to generate a stylized 3D face mesh.

MAGE 710 may be trained in a direction that transforms randomly sampled shape parameter β and expression parameter φ into z^{s} and z^{e} through the mapping network of the surface deformation network 410, and minimizes the MSE loss with the predicted values \hat{z}^{s} and \hat{z}^{e} of MAGE 710. Through this training method, MAGE 710 may be trained to extract latent space vectors used in the stylized 3D face mesh generation model 510 for various face topologies.

According to FIG. 7, an encoder may be constructed that takes face meshes of various topologies as input and extracts latent space vectors that may be used in the stylized 3D face mesh generation model 510.

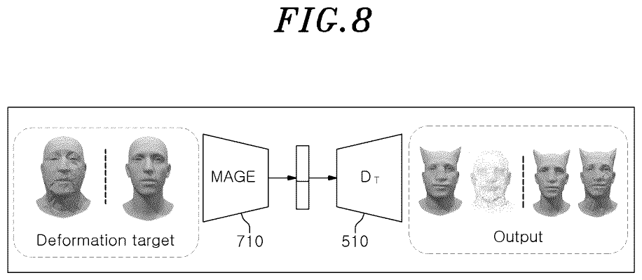

FIG. 8 is a diagram illustrating an inference process of a stylized 3D face mesh generation model according to an embodiment.

After the surface deformation network 410, the stylized 3D face mesh generation model 510, and MAGE 710 are trained through the training processes of FIGS. 4 to 7, when a mesh for a predetermined deformation target is input, a stylized 3D face mesh generation model 510 capable of generating a stylized 3D face mesh may be constructed. Specifically, a 3D face mesh may be provided to MAGE 710 to output a latent vector, and the output latent vector may be provided to the stylized 3D face mesh generation model 510 to generate a stylized 3D face mesh. When the topology of the input 3D face mesh is varied, a stylized 3D face mesh may be generated according to various topologies.

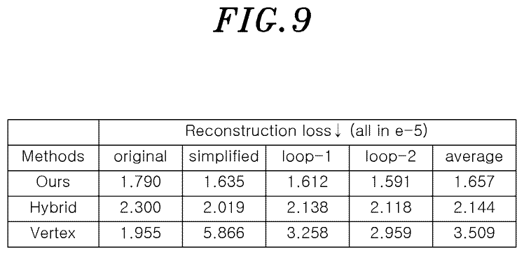

FIG. 9 is a table illustrating a comparison result between a stylized 3D face mesh generation method according to an embodiment and a conventional mesh sampling method in terms of mesh reconstruction.

Referring to FIG. 9, it may be seen that the stylized 3D face mesh generation method according to an embodiment of the present invention has the lowest reconstruction loss for various topologies compared to the conventional mesh sampling method.

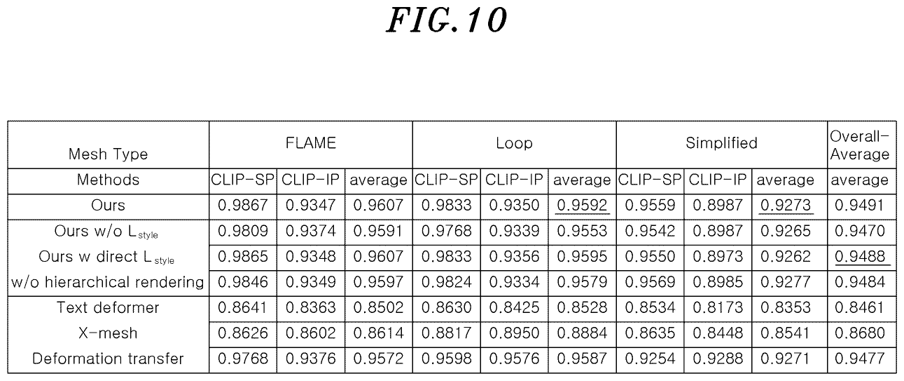

FIG. 10 is a table illustrating a comparison result between a stylized 3D face mesh generation method and a conventional 3D face mesh generation method for an ablation study.

In the table of FIG. 10, the first column represents the mesh form for the experiment, and CLIP-SP and CLIP-IP respectively represent a style preservation score and an identity preservation score for the result of the stylized 3D face mesh. A higher average of the two preservation scores means higher performance of the model, and through this, it may be confirmed how harmoniously the identity of the input face and the target style are maintained in the stylized face. Referring to FIG. 10, it may be seen that the stylized 3D face mesh generation method according to an embodiment of the present invention has the highest average of the two preservation scores compared to the conventional 3D face mesh generation method, indicating the best performance.

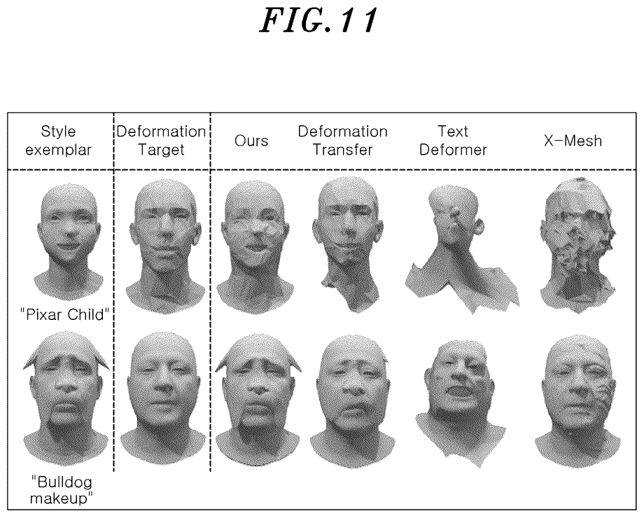

FIG. 11 is a diagram illustrating a comparison result between a stylized 3D face mesh generation method and a conventional 3D face mesh generation method in terms of stylization performance.

Referring to FIG. 11, it may be seen that the stylized 3D face mesh generation method according to an embodiment is superior in terms of stylization performance compared to the conventional 3D face mesh generation method.

As described above, according to an embodiment, by automating the complex process of 3D avatar face modeling in the film and game industries, a stylized 3D face mesh that may harmoniously combine a character's ‘style’ and a specific person's ‘identity’ may be generated.

Furthermore, since a stylized 3D face mesh may be generated corresponding to various face topologies, time and costs in the character design process may be significantly reduced. In particular, a stylized face of a desired topology may be generated from various forms of face meshes through a Mesh Agnostic Encoder (MAGE). Based on this, creators may reuse existing animation rigs and texture maps for other models, maximizing work efficiency.

Furthermore, high-quality, various stylized faces may be generated even with a small amount of data, and accordingly, the difficulty and cost of data collection may be significantly reduced. Therefore, user-customized 3D avatars may be easily generated and utilized on social media and virtual reality (VR) platforms.

Furthermore, the method for generating a stylized 3D face mesh according to an embodiment may be used in various application fields. For example, the efficiency of character design and animation tasks in the film and game industries is improved, and user-customized 3D avatars may be easily generated on social media and virtual reality (VR) platforms. Through this, an embodiment supports the production of creative and realistic digital content throughout the cultural content industry, and may further contribute to enhancing the user experience.

The embodiments described above may be implemented through various means. For example, the embodiments may be implemented by hardware, firmware, software, or a combination thereof.

The combinations of each block of the block diagrams and each step of the flowcharts of an embodiment may also be performed by computer program instructions. These computer program instructions may be loaded onto an encoding processor of a general-purpose computer, a special-purpose computer, or other programmable data processing equipment, so that the instructions performed through the encoding processor of the computer or other programmable data processing equipment create means for performing the functions described in each block of the block diagram or each step of the flowchart. These computer program instructions may also be stored in a computer-usable or computer-readable memory that may direct a computer or other programmable data processing equipment to implement functions in a specific way, so that the instructions stored in the computer-usable or computer-readable memory may also produce an article of manufacture embodying instruction means for performing the functions described in each block of the block diagram or each step of the flowchart. The computer program instructions may also be loaded onto a computer or other programmable data processing equipment, so that a series of operational steps are performed on the computer or other programmable data processing equipment to create a computer-implemented process, so that the instructions that execute the computer or other programmable data processing equipment may also provide steps for executing the functions described in each block of the block diagram and each step of the flowchart.

Furthermore, each block or each step may represent a part of a module, segment, or code including one or more executable instructions for executing a specified logical function(s). In some embodiments, the functions mentioned in the blocks or steps may also occur out of order. For example, two blocks or steps shown in succession may in fact be performed substantially simultaneously, or the blocks or steps may sometimes be performed in the reverse order, depending on the corresponding function.

The above description is merely illustrative of the technical idea of an embodiment, and various modifications and variations will be possible for those with ordinary skill in the art to which an embodiment pertains without departing from the essential qualities of an embodiment. Therefore, the embodiments disclosed herein are not for limiting the technical idea of an embodiment but for explaining it, and the scope of the technical idea of an embodiment is not limited by these embodiments. The protection scope of an embodiment should be interpreted by the following claims, and all technical ideas within the equivalent scope should be interpreted as being included in the scope of rights of an embodiment.

What is claimed is:

1. A method for generating a stylized 3D face mesh, to be performed by a stylized 3D face mesh generation apparatus, the method comprising:
providing a 3D face mesh to an encoder so that the encoder extracts a shape latent vector for a shape parameter and an expression latent vector for an expression parameter; and
providing the shape latent vector and the expression latent vector to a stylized 3D face mesh generation model to generate a stylized 3D face mesh.

2. The method of claim 1, wherein the encoder is pre-trained to output respective latent vectors for a face shape and an expression of an input 3D face mesh.

3. The method of claim 1, wherein the encoder includes a first multi-layer perceptron (MLP) that outputs the shape latent vector based on the 3D face mesh and a second MLP that outputs the expression latent vector based on the 3D face mesh.

4. The method of claim 1, wherein the stylized 3D face mesh generation model is pre-trained to:
generate a stylized 3D face mesh based on a reference 3D face mesh,
a target deformed 3D face mesh whose style is deformed from the reference 3D face mesh,
a deformed 3D face mesh whose style is deformed from the reference 3D face mesh through the stylized 3D face mesh generation model,
a sampled 3D face mesh generated based on a latent vector randomly sampled from a database, and
a deformed sampled 3D face mesh whose style is deformed from the sampled 3D face mesh through the stylized 3D face mesh generation model.

5. The method of claim 4, wherein the reference 3D face mesh and the sampled 3D face mesh are generated through a surface deformation network, and
wherein the surface deformation network is pre-trained to generate a 3D face mesh by receiving the shape parameter and the expression parameter as input, based on a target 3D face mesh output from a statistics-based 3D face mesh generation model.

6. The method of claim 5, wherein in the training of the stylized 3D face mesh generation model, the stylized 3D face mesh generation model is trained to minimize a vertex difference between the target deformed 3D face mesh and the deformed 3D face mesh, while maintaining parameters of the surface deformation network.

7. The method of claim 5, wherein in the training of the stylized 3D face mesh generation model, the stylized 3D face mesh generation model is trained to minimize a difference in contrastive language-image pre-training (CLIP) embedding values between the target deformed 3D face mesh and the deformed 3D face mesh, while maintaining parameters of the surface deformation network.

8. The method of claim 5, wherein in the training of the stylized 3D face mesh generation model, the stylized 3D face mesh generation model is trained to minimize a difference in surface normal values between the target deformed 3D face mesh and the deformed sampled 3D face mesh, while maintaining parameters of the surface deformation network.

9. The method of claim 5, wherein in the training of the stylized 3D face mesh generation model, the stylized 3D face mesh generation model is trained to minimize a difference between a direction of a difference vector for a CLIP embedding value for the reference 3D face mesh and a CLIP embedding value for the sampled 3D face mesh, and that of a difference vector for a CLIP embedding value for the target deformed 3D face mesh and a CLIP embedding value for the deformed sampled 3D face mesh, while maintaining parameters of the surface deformation network.

10. The method of claim 5, wherein in the training of the stylized 3D face mesh generation model, the stylized 3D face mesh generation model is trained to minimize a difference between a direction of a difference vector for a CLIP embedding value for the reference 3D face mesh and a CLIP embedding value for the target deformed 3D face mesh, and that of a difference vector for a CLIP embedding value for the sampled 3D face mesh and a CLIP embedding value for the deformed sampled 3D face mesh, while maintaining parameters of the surface deformation network.

11. A method for training a stylized 3D face mesh generation model, to be performed by a training apparatus, the method comprising:
pre-training a surface deformation network to generate a 3D face mesh by receiving a shape parameter and an expression parameter as input, based on a target 3D face mesh output from a statistics-based 3D face mesh generation model;
obtaining a reference 3D face mesh generated through the surface deformation network and a target deformed 3D face mesh whose style is deformed from the reference 3D face mesh; and
training the stylized 3D face mesh generation model based on the reference 3D face mesh and the target deformed 3D face mesh.

12. A stylized 3D face mesh generation apparatus, comprising:
a memory storing computer-executable instructions; and
a processor,
wherein as the computer-executable instructions are executed by the processor, the processor is configured to:
extract a shape latent vector for a shape parameter and an expression latent vector for an expression parameter by providing a 3D face mesh to an encoder, and
generate a stylized 3D face mesh by providing the shape latent vector and the expression latent vector to a stylized 3D face mesh generation model.

13. The apparatus of claim 12, wherein the encoder is pre-trained to output respective latent vectors for a face shape and an expression of an input 3D face mesh.

14. The apparatus of claim 12, wherein the encoder includes a first multi-layer perceptron (MLP) that outputs the shape latent vector based on the 3D face mesh and a second MLP that outputs the expression latent vector based on the 3D face mesh.

15. The apparatus of claim 12, wherein the stylized 3D face mesh generation model is pre-trained to:
generate a stylized 3D face mesh based on a reference 3D face mesh,
a target deformed 3D face mesh whose style is deformed from the reference 3D face mesh,
a deformed 3D face mesh whose style is deformed from the reference 3D face mesh through the stylized 3D face mesh generation model,
a sampled 3D face mesh generated based on a latent vector randomly sampled from a database, and
a deformed sampled 3D face mesh whose style is deformed from the sampled 3D face mesh through the stylized 3D face mesh generation model.

16. The apparatus of claim 15, wherein the reference 3D face mesh and the sampled 3D face mesh are generated through a surface deformation network, and
wherein the surface deformation network is pre-trained to generate a 3D face mesh by receiving the shape parameter and the expression parameter as input, based on a target 3D face mesh output from a statistics-based 3D face mesh generation model.

17. A non-transitory computer-readable storage medium storing computer-executable instructions that, when executed by a processor, cause the processor to perform a method comprising:
providing a 3D face mesh to an encoder so that the encoder extracts a shape latent vector for a shape parameter and an expression latent vector for an expression parameter; and
providing the shape latent vector and the expression latent vector to a stylized 3D face mesh generation model to generate a stylized 3D face mesh.
